(19) United States
(12) Patent Application Publication
(10) Pub. No.: US 2001/0050693 A1
(43) Pub. Date: Dec. 13, 2001

(54) Multi-function switch device

(75) Inventors: Hiroshi Nishiyama, Shizuoka (JP); Fumie Mukasa, Shizuoka (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: Yazaki Corporation, Tokyo (JP)

(21) Appl. No.: 09/875,085

(22) Filed: Jun. 7, 2001

(30) Foreign Application Priority Data
Jun. 8, 2000 (JP) 2000-171706

(51) Int. Cl. G06F 3/00

(52) U.S. Cl. 345/811; 345/810

(57) ABSTRACT

One of a plurality of operation modes is registered manually or automatically registered as a default operation mode. This configuration provides a multi-function switch device capable of reducing the number of times an operation.

### BACKGROUND OF THE INVENTION

1. Field of the Invention

This invention relates to a multi-function switch which is commonly used to select the operation contents relative to a plurality of appliances.

2. Description of the Related Art

Traditionally, an electric appliance such as an audio appliance or air conditioner loaded in a vehicle is individually provided with operation switches for selecting operation contents. These operation switches are arranged on a center console within the vehicle. However, in each electric appliance, development of technology led to function diversification. This has increased the number of operation switches.

Therefore, it has become difficult to arrange all the necessary operation switches on the center console within a limited space. In addition, the presence of a large number of operation switches may uglify the design of the center console.

In order to solve such a problem, such a multi-function switch device as explained below has been proposed. In this switch device, a liquid-crystal (LC) display is arranged behind the operation switches. The LC display displays a character corresponding to the operation mode selected by a selective operation switch among a plurality of operation modes such as an audio operation mode, an air conditioner operation mode, etc.

On the basis of the display, the operation contents corresponding to the character displayed on the LC display can be selected by the switch. The multi-function switch device described above, which is designed so that a plurality of operations can be executed by a single operation switch, has reduced the number of the operation switches.

However, the operator which operates the above multi-function switch device, when the operation mode which he wants to select has not yet been selected, makes the operation using the operation switch after the desired operation mode has been selected by the selective operation switch. This increases the number of operations of the switch so that the switch operation becomes a burden for the operator. Particularly, where the operator is a vehicle driver, his attention is dispersed to a handle operation and a switch operation so that instantaneous decision during the driving is not made. This is also problematic from the standpoint of view of safety.

### SUMMARY OF THE INVENTION

An object of this invention is to provide a multi-function switch which can facilitate a switch operation by placing the operation mode used frequently in a default.

In order to attain the above object, in accordance with this invention, there is provided a multi-function switch device as shown in FIG. 1 which shows a basic arrangement of this invention, The multi-function switch devices comprises:

first selecting means 11 for selecting one of a plurality of operation modes to be set as a set operation mode;

setting means 51a for setting the selected operation mode as the set operation mode;

display means 31 for displaying a character corresponding to the set operation mode; and operating means 3 for executing an operation corresponding to the character.

The multi-function switch device further comprises monitoring means 51b for monitoring an operating status of the selecting means and the operating means; and automatic registering means 51c for automatically registering one of the plurality of operation modes as a default operation mode. In this multi-function switch device, the setting means sets the default operation mode as the set operation mode when no operation mode is selected by the selecting means.

In this configuration, if the automatic registering means registers the operation mode with high frequency of use as a default operation mode on the basis of the operation status of the above first selecting means and the operating means, the setting means can set the default operation mode as the set operation mode when no operation mode is selected by the first selecting means. This permits the number of times of selecting the operation modes by the first selecting means to be reduced. In addition, since the automatic registering means automatically registers the default operation mode, an operator is not required to register the default operation mode manually.

In a preferred embodiment, the operation status is number of times of operation of the operating means counted for each operation mode, number of times of selection of the operation mode by the selecting means or a set time for each the operation modes. Such an operation status corresponds to the frequency of use of each operation mode. Therefore, using the automatic registering means, the operation mode with high frequency of use can be surely registered as the default operation mode so that the number of times of selecting the operation mode to be set can be surely reduced.

In the preferred embodiment, as seen from FIG. 1A, the multi-function switch device further comprises manual registering means 51d having second selecting means 12 for selecting one of a plurality of operation modes to be registered as a default operation mode. The manual registering means registers the selected operation mode manually as the default operation mode. This configuration permits an operator to register the default operation mode manually and freely.

In the preferred embodiment, as seen from FIG. 1A, the above multi-function switch device, further comprises:

canceling means 51e for canceling the default operation mode registered by the manual registering means when it is selected by the second selecting means. This configuration permits the operator to cancel the registered default operation mode freely using the canceling means 12.

In the preferred embodiment, as seen from FIG. 1A, the multi-function switch device further comprises first invalidating means 51f for invalidating the default operation mode registered by the automatic registering means when it is registered by the manual registering means. This configuration permits the manual registering of the default operation mode to be given higher priority to the automatic registering.

In the preferred embodiment, in the multi-function switch device, the setting means sets the operation mode corresponding to the first selecting means as the set operation mode when the first selecting means is operated in a first predetermined selecting operation, and

the manual registering means uses the first selecting means as the second selecting means to register the operation mode corresponding to the first selecting means as the default operation mode when the first selecting means is operated in a second predetermined selecting operation.

In this configuration, the first selecting means is also used as the second selecting means so that it is not necessary to provide the second selecting means separately.

In accordance with the second aspect of this invention, there is provided a multi-function switch device as shown in FIG. 1B. The multi-function switch device comprises:

first selecting means 11 for selecting one of a plurality of operation modes to be set as a set operation mode;

setting means 51a for setting the selected operation mode as the set operation mode;

display means 31 for displaying a character corresponding to the set operation mode;

operating means 3 for executing an operation corresponding to the character.

The multi-function switch device further comprises manual registering means 51d having second selecting means 61 for selecting one of a plurality of operation modes to be registered as a default operation mode. The manual registering means 51d registers the selected operation mode manually as the default operation mode. The setting means 11 sets the default operation mode as the set operation mode when no operation mode is selected by the second selecting means.

In the preferred embodiment, the manual registering means includes a plurality of registering units, and the switch devices further comprises

third selecting means for selecting one of default operation modes registered by the plurality of registering units; and

second invalidating means for invalidating the other default operation modes than the default operation mode selected by the third selecting means.

In this configuration, since the manual registering means includes a plurality of registering units, and one of the plurality of default operation modes is selected by the third selecting means, a plurality of operators can individually register the default operation modes optimum for themselves.

In the preferred embodiment, the second invalidating means invalidates the other default operation mode than the default mode corresponding to the third selecting means when the third selecting means is operated in a third predetermined selecting operation, and

the manual registering means uses the second selecting means as the third selecting means to register the operation mode corresponding to the first selecting means as the default operation mode when the third selecting means is operated in a fourth predetermined selecting operation.

In this configuration, since the third selecting means is used as the second selecting means, it not required that they are individually provided.

In the preferred embodiment of the multi-function switch device

the setting means sets the default operation mode as the set operation mode when the default operation mode is not the set operation mode and the operating means is not operated continuously for a predetermined time or longer. In this configuration, the number of times of selecting operation modes by the first selecting means can be further reduced.

The above and other objects and features of the invention will be more apparent from the following description taken in conjunction with the accompanying drawings.

### BRIEF DESCRIPTION OF THE DRAWINGS

FIGS. 1A and 1B are block diagrams showing the basic arrangement of a multi-function switch device according to this invention, respectively;

FIG. 2 is a front view of a main part of the multi-function switch according to this invention;

FIG. 3 is a sectional view of a multiple switch constituting a multi-function switch device shown in FIG. 2;

FIG. 4 is a block diagram showing an embodiment of the multi-function switch device according to this invention;

FIG. 5 is a flowchart showing an example of the processing procedure in a CPU constituting the multi-function switch device shown in FIG. 4;

FIG. 6 is a flowchart showing the procedure of interrupting processing in the CPU constituting the multi-function switch shown in FIG. 1;

FIG. 7 is a flowchart for explaining the details of manual registering processing in FIG. 6;

FIG. 8 is a flowchart for explaining the details of automatic registering processing in FIG. 6;

FIG. 9 is a flowchart showing the procedure of interrupting processing in the CPU constituting the multi-function switch device shown in FIG. 4;

FIGS. 10A and 10B are pictorial views showing examples of display of a liquid crystal display constituting a multi-function switch shown in FIG. 2, 3 or 4;

FIG. 11 is a front view of the main part of the multi-function switch device according to this invention;

FIG. 12 is a flowchart showing an example of the processing procedure in a CPU constituting the multi-function switch device shown in FIG. 11; and

FIG. 13 is a flowchart for explaining the details of manual registering processing in the CPU constituting the multi-function switch device shown in FIG. 11.

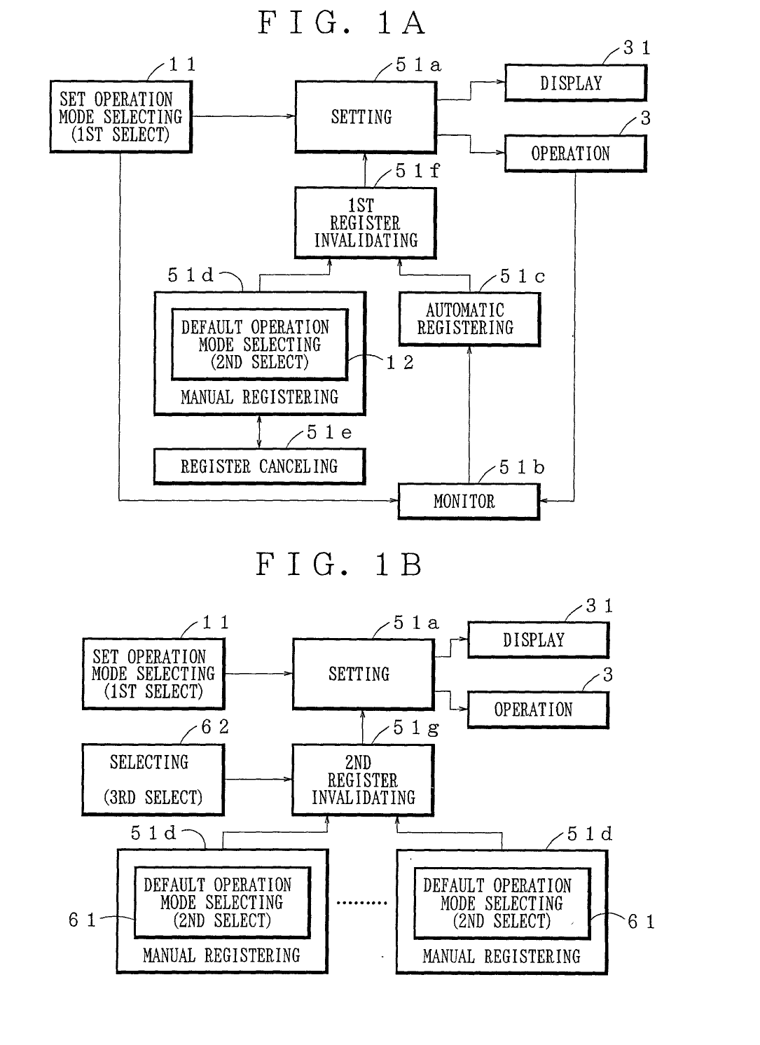

### DESCRIPTION OF THE PREFERRED EMBODIMENTS

Embodiment 1

Now referring to the drawings, an explanation will be given of a first embodiment of this invention. This invention intends to relax a switch operation by default-displaying the operation mode with high frequency of use which has been registered automatically or manually.

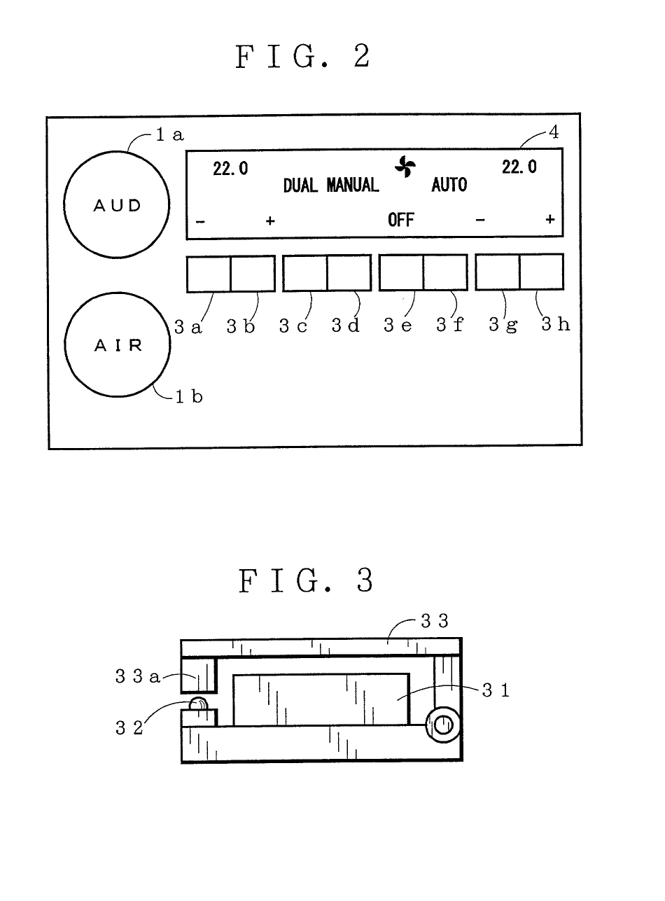

FIG. 2 shows a combination panel constituting a multi-function switch device according to this invention. As seen from FIG. 2, the combination panel includes a switch 1a (hereinafter referred to as an AUD selective switch 1a) for selecting an audio operation mode, and a switch 2 (hereinafter referred to as an AIR selective switch 1b) for selecting an air conditioner operation mode.

The AUD selective switch 1a and the AIR selective switch 1b constitute a means for selecting a set operation mode. The combination panel also includes a plurality of multi-switches 3a-3h which serve as operating means, respectively and a center display for displaying the contents of each switch.

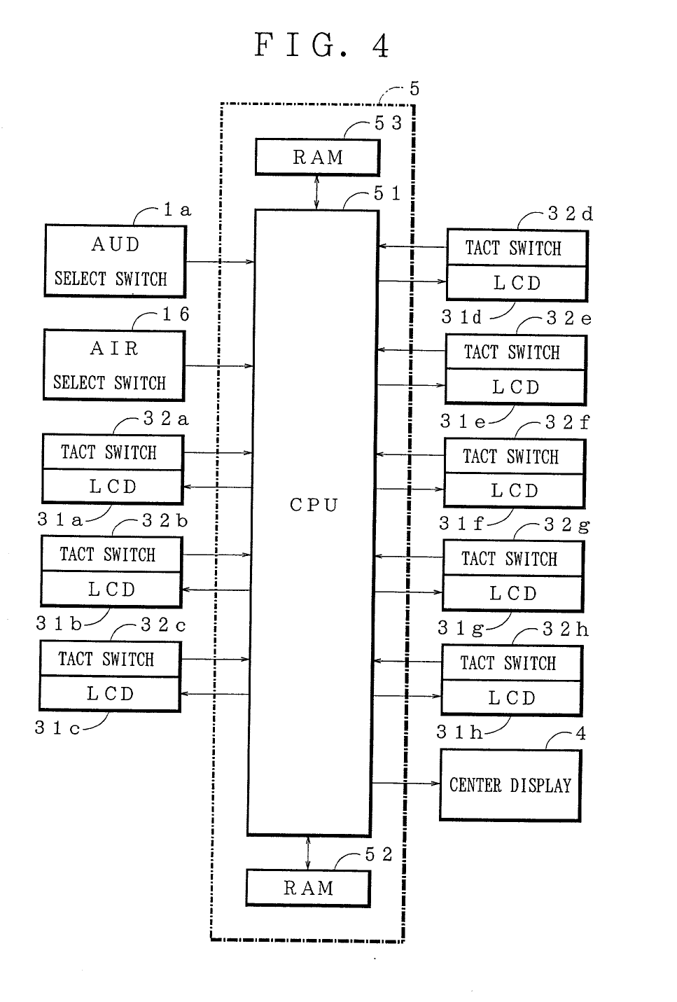

The multi-switches 3a-3h each, as shown in FIG. 3, includes an liquid crystal display (LCD) 31 which is a display means for displaying the character relative to the function of the pertinent switch, a tact switch 32 which turns on when pressed, and a light permeable member 33 which is located on the front face of the LCD 32 and has a pressing piece 33a for pressing the tact switch 32 at its one end. Such a configuration permits the image displayed on the LCD 31 to be recognized visually through the light permeable member 33. When the light permeable member 33 is pressed, the pressing piece 33a turns on the tact switch 32.

The ADU selective switch la, AIR selective switch 1b and tact switches 32a-32h corresponding to the multi-switches 3a-3h are connected to a microcomputer 5 (hereinafter referred to as a μCOM 5). The respective LCDs 31a-31h corresponding to the multi-switches 3a-3h and the center display 4 are also connected to the μCOM 5.

The μCOM 5 includes a CPU 51 which operates in accordance with a prescribed control program, a ROM 51 for storing a control program for the CPU 51 and a RAM 53 for temporarily storing the data necessary to execute the computation by the CPU 51. When the ADU selective switch 1a or the AIR selective switch 1b is pressed for a time of T1 or shorter, the CPU 51 sets the operation mode corresponding to the pertinent selective switch. This pressing operation for T1 or shorter is hereinafter referred to as a switch operation, which is defined as a first predetermined operation in claims.

The CPU 51 performs processing of displaying the character corresponding to the set operation mode on the LCDs 31a - 31h, processing of monitoring the operating condition of the DU selective switch la, AIR selective switch 1b or multi-switches 3a-3h and processing of automatically registering the audio operating mode or air conditioner operating mode as a default mode on the basis of the monitored operating condition.

When the ADU switch 1a or AIR selective switch 1b is kept on being pressed for a time exceeding T1, the CPU 51 performs processing of manually registering the operation mode corresponding to the selective switch being pressed as a default operating mode. The pressing operation for the time exceeding time T1 is referred to as a long-time pressing operation, which is defined as a second predetermined operation in claims. Further, the CPU 51 performs processing of invalidating the registering of the default operation mode by the automatic registering processing when the default operation mode has been registered by the manual registering mode.

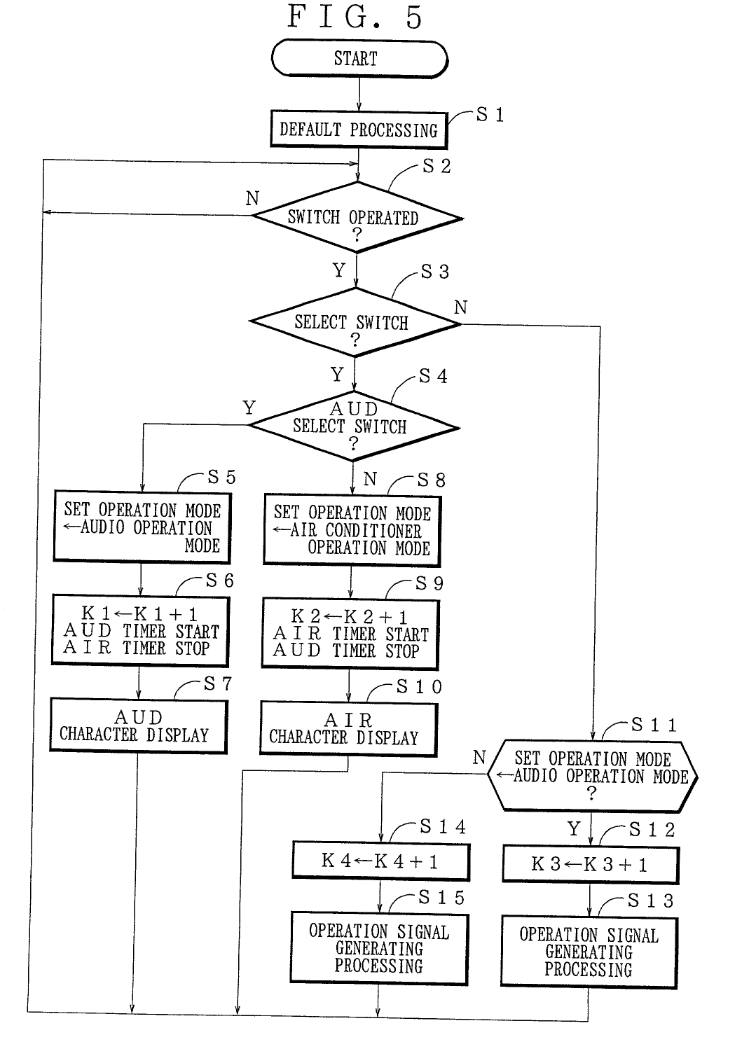

Now referring to the flowcharts shown in FIGS. 5 to 9 showing the processing procedure by the CPU 51, an explanation will be given of the multi-function switch device having the configuration described above.

The CPU 51 starts to operate when e.g. an ignition switch is turned on. After the CPU 51 has made resetting for various areas formed in the RAM 53 in a preparation step (not shown) it proceeds to a first step S1

First, the CPU 51 performs default processing (step S1). The default processing is to set a previously registered default operation mode for a set operation mode and display the character corresponding to the operation mode thus set. Immediately after the ignition switch is turned on, this processing permits the operation mode to be set at that previously registered as a default mode when no operation mode is still selected by the AUD selective switch nor AIR selective switch 1b.

The default operation mode includes two modes registered manually (in manual registering processing) and automatically (in automatic registering processing), as described later.

The CPU 51 preferentially sets the default operation mode registered manually as the set operation mode, and invalidates that registered automatically. Only when the default operation mode has not been registered in the manual registering processing, the CPU 51 sets the default operation mode registered automatically as the set operation mode. As understood from the above operation, the CPU 51 constitutes the operation mode setting means and the first registering invalidating means.

The CPU 51 determines whether or not the switch operation for the AUD selective switch la, AIR selective switch 1b or multi-switch 3a-3h have been done (step S2). For example, if the switch operation of the AUD selective switch 1a has been done by an operator (Y in step S3 and Y in step S4), the CPU 51 serves as the setting means which sets again the audio operation mode as the set operation mode (step S5).

The CPU 51 increments the count area K1 formed within the RAM 53. Therefore, the number of times of operation by the AUD selective switch 1a is counted in the count area K1. Simultaneously, the counting of an audio timer which counts the time while the audio operation mode is set is started, and the counting of an air conditioner timer which counts the time while the air conditioner operation mode is set is stopped (step S6).

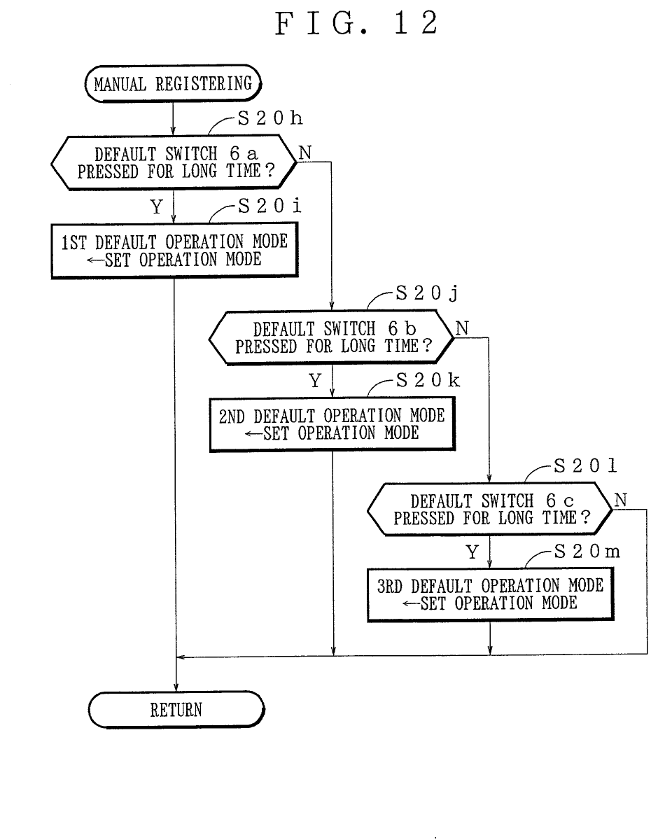

The number of times of operation of the AUD selective switch 1a and the count value of the audio timer represent the operation status of the AUD selective switch 1a. In this case, the CPU 51 serves as a monitoring means in step S6. As shown in FIG. 10A, after the CPU 51 causes the respective LCDs 31a-31h to display the characters corresponding to the audio operation mode (step S7), The CPU 51 returns to step S2.

If the switch operation of the AIR selective switch 1b has been done by an operator (Y in step S3 and N in step S4), the CPU 51 serves as the setting means which sets again the air conditioner operation mode as the set operation mode (step S8). The CPU 51 increments the count area K2 formed within the RAM 53. Therefore, the number of times of operation by the AIR selective switch 1b is counted in the count area K2. Simultaneously, the counting of the air conditioner timer is started, and the counting of the audio timer is stopped (step S9).

The number of times of operation of the AIR selective switch 1b and the count value of the air conditioner timer represents the operation status of the AIR selective switch 1b. In this case, the CPU 51 serves as a monitoring means in step S9. As shown in FIG. 10B, after the CPU 51 causes the respective LCDs 31a- 31h to display the characters corresponding to the air conditioner operation mode (step S10), The CPU 51 returns to step S2.

If the switch operation of the multi-switch 3a-3h has been done by the operator (N in step S3), the CPU 51 determines whether or not the audio operation mode has been set as the set operation mode (step S11). At this time, if the audio operation mode has been set (Y in step S11), the CPU 51 increments the count area K3 formed within the RAM 53 (step S12).

Therefore, the number of times of operation of the multi-switches 3a-3h in the audio operation mode is stored as its operation status in the count area K3. In this step 12 also, the CPU 51 serves as the monitoring means.

After the CPU 61 has produced an operation signal corresponding to the operated multi-switch 3a-3h, The CPU 51 returns to step S2 (step S13). In this processing of producing the operation signal, for example, when the multi-switch 3a has been operated, the CPU 51 produces an operating signal indicative of the connection to “AM” (FIG. 10A). In this case, an AM radio receiver which has received the operation signal is adapted to receive an AM radio wave.

When the switch operation of the multi-switch 3a-3h has been done by the operator, if the air conditioner operation mode has been set (N in step S11), the CPU 51 increments the count area K4 formed within the RAM 53 (step S14). Therefore, the number of times of operation of the multi-switches 3a-3h in the air conditioner operation mode is stored as its operation status in the count area K4. In this step 14 also, the CPU 51 serves as the monitoring means.

After the CPU 61 has produced an operation signal corresponding to the operated multi-switch 3a-3h, the CPU 51 returns to step S2 (step S15). In this processing of producing the operation signal, for example, when the multi-switch 3a has been operated, the CPU 51 produces an operating signal indicative of the turn-off of the air conditioner (FIG. 10B). In this case, an air conditioner which has received the operation signal is adapted to stop its operation.

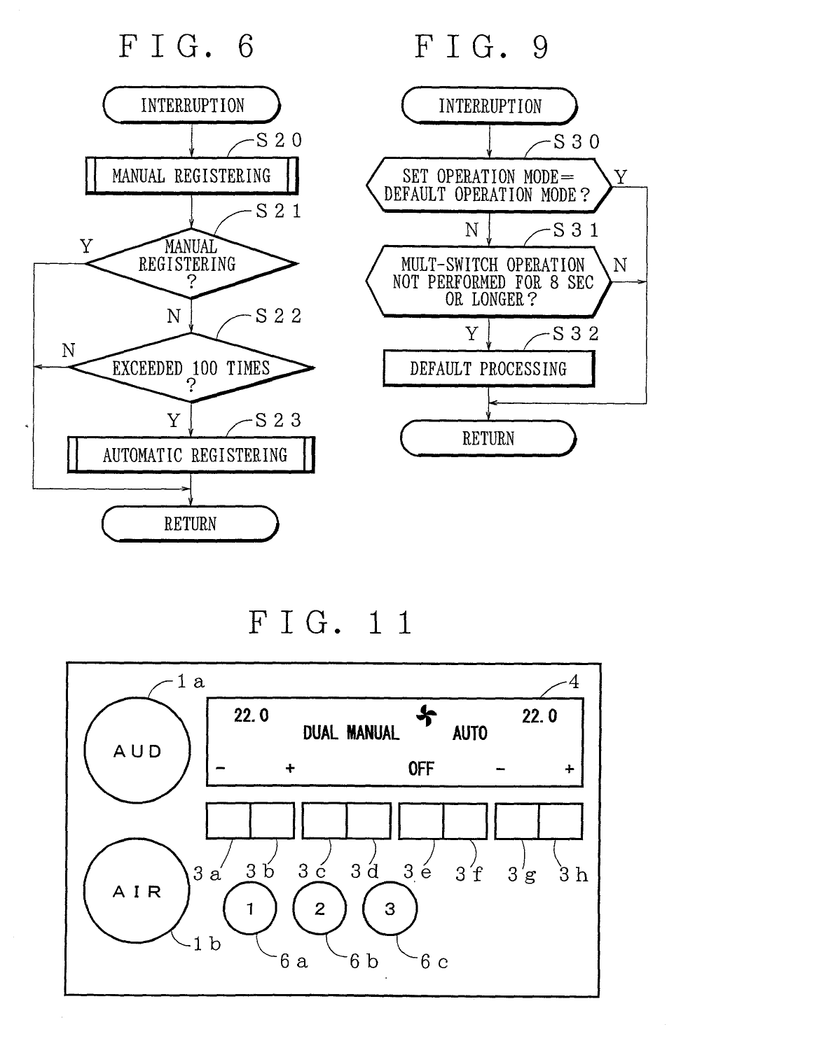

The CPU 51 performs interrupting processing at every prescribed times as shown in the flowchart in FIG. 6. In the interrupting processing, the CPU 51 performs the manual registering processing described later (step S20). If the default operation mode has been registered in the manual registering processing (YES in step S21), the CPU 51 immediately returns to the original state.

On the other hand, if not registered (N in step S21), the CPU 51 determines whether or not the total of the count values stored in the count areas K1, K2, K3 and K4 has exceeded 100, namely the total of the number of times of the operations of the AUD selective switch 1a, AIR selective switch 1b or the multi-switches 3a-3h has exceeded 100 (step S22).

If the number of times of operation has exceeded 100 (Y in step S22), The CPU 51 returns to the original state after the automatic registering processing has been performed (step S23). On the other hand, if it does not still exceed 100 (N in step S22), the CPU 51 immediately returns to the original state.

Referring to the flowchart of FIG. 7 showing the processing procedure of the CPU 51, an explanation will be given of the details of the above manual registering processing. First, if the AUD selective switch 1a has been pressed for a long time or subjected to the long-time pressing operation (Y in step S20a), the CPU 51 determines whether or not the audio operation mode has been set as the default operation mode (step S20b).

If not registered (N in step S20b), under the judgment that the registering operation has just been performed by the operator, the CPU 51 registers the audio operation mode as a default operation mode (step S20c). Thereafter, The CPU 51 returns to the original state. On the other hand, if registered (Y in step S20b), under the judgement that the operation of canceling the default operation mode has been just performed by the operator, the CPU 51 cancels the registering of the audio operation mode (step S20d). Thereafter, The CPU 51 returns to the original state (step S20d).

If the AIR selective switch 1b has been subjected to the long-time pressing operation (Y in step S20e), the CPU 51 determines whether or not the air conditioner operation mode has been set as the default operation mode (step S20f). If not registered (N in step S20f), under the judgment that the registering operation has just been performed by the operator, the CPU 51 registers the air conditioner operation mode as a default operation mode (step S20g). Thereafter, The CPU 51 returns to the original state. On the other hand, if registered (Y in step S20f), under the judgement that the operation of canceling the default operation mode has been just performed by the operator, the CPU 51 cancels the registering of the air conditioner operation mode (step S20d). Thereafter, The CPU 51 returns to the original state. If neither the AUD selective switch 1a nor the AIR selective switch 1b has been subjected to the long-time pressing operation (N in step S20e), the CPU 51 immediately returns to the original state.

By way of the manual registering processing described above, the operator can manually freely perform the registering/canceling of the default operation mode. In this processing, the CPU 51 serves as the manual registering means and registering canceling means. The selective switches 1a and 1b also serve as the default operation mode selecting means.

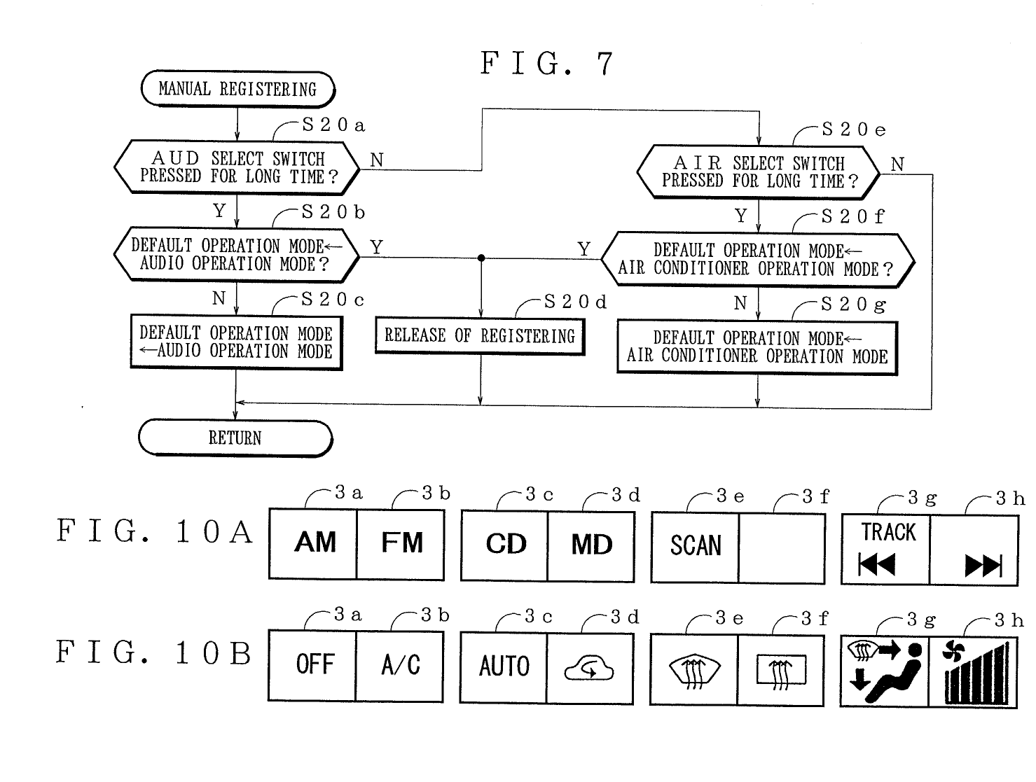

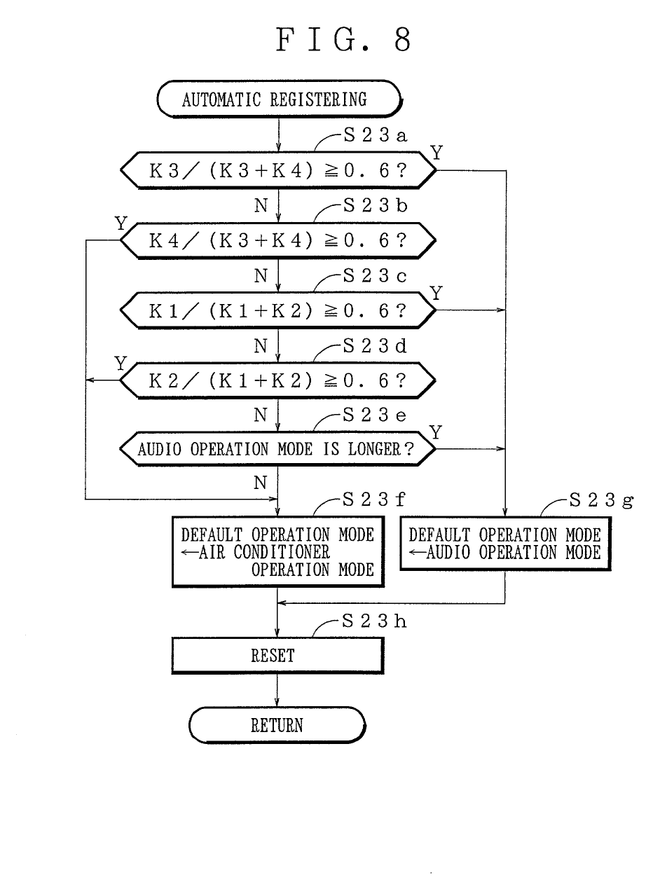

Referring to the flowchart of FIG. 8 showing the processing procedure of the CPU 51, an explanation will be given of the details of the above automatic registering processing. First, the CPU 51 determines whether or not K3/(K3+K4)≧0.6 (step S23a). In this step, it is determined whether or not the percentage of the number of times of operation of the multi-switches 3a-3h in the audio operation mode of the number of operation of the multi-switches 3a to 3h is 60% or more.

If K3/(K3+K4)≧0.6 (Y in step S23a), under the judgement that the audio operation mode is being used at frequent intervals, the CPU 51 registers the audio operation mode as the default operation mode (step S23g). On the other hand, if K3/(K3+K4)<0.6 (N in step S23a),the CPU 51 determines whether or not K4/(K3+K4)≧0.6 (step S23b). Namely, in this step, it is determined whether or not the percentage of the number of times of operation of the multi-switches 3a-3h in the air conditioner operation mode of the number of operation of the multi-switches 3a to 3h is 60% or more.

If K4/(K3 +K4)≧0.6 (Y in step S23b), under the judgement that the air conditioner operation mode is being used at frequent intervals, the CPU 51 registers the air conditioner operation mode as the default operation mode (step S23f). On the other hand, if K4/(K3+K4)<0.6 (N in step S23), the CPU 51 determines whether or not K1/(K1+K2)≧0.6 (step S23c). Namely, in this step, it is determined whether or not the percentage of the number of times of operation of the audio selective switch 1a in the operation mode of the number of operation of the selective switches 1a and 1b is 60% or more.

If K1/(K1+K2)≧0.6 (Y in step S23c), under the judgement that the audio operation mode is being used at frequent intervals, the processing proceeds to step S23g. On the other hand, if K1/(K1+K2)<0.6 (N in step S23c), the CPU 51 determines whether or not K1/(K1+K2)≧0.6 (step S23d). Namely, in this step, it is determined whether or not the percentage of the number of times of operation of the AIR selective switch 1b in the operation mode of the number of operation of the selective switches 1a and 1b is 60% or more.

If K2/(K1+K2)≧0.6 (Y in step S23d), under the judgement that the air conditioner operation mode is being used at frequent intervals, the CPU 51 proceeds to step S23f. On the other hand, if K2/(K1+K2)<0.6 (N in step S23d), the count values in the audio timer and air conditioner time are compared with each other to determine whether or not the time set for the audio operation mode is longer than that for the air conditioner operation mode (step S23e).

If the time for the audio operation mode is longer than that for the air conditioner mode (Y in step S23e), under the judgement that the audio operation mode is being used at frequent intervals, the processing proceeds to step S23g. On the other hand, if the time for the air conditioner operation mode is longer than that for the audio operation mode (N in step S23e), under the judgement that the air conditioner operation mode is being used at frequent intervals, the processing proceeds to step S23f. After the processing has proceeded to the step S23g or 23f, the CPU 51 performs the reset operation of resetting the count areas K1, K2, K3 and K4, audio timer and air conditioner timer (step S23h). Subsequently, the CPU 51 returns to the original state.

By way of the automatic registering processing described above, the default operation mode can be automatically registered so that the operator is not required to register the default operation mode, and can save the time and labor of registering the default operation mode.

In the automatic registering processing, the CPU 51 automatically sets the default operation mode on the basis of the operation status such as the number of times of operation of the multi-switches 3a-3h, the number of times of selection of each operation mode by the selective switches 1a and 1b, or the setting continuing time for each operation mode. This operation status is based on the frequency of using each operation mode. Therefore, the automatic registering processing described above permits the operation mode with high frequency of use to be surely registered as the default operation mode. In the automatic registering processing, the CPU 51 servers as the automatic registering means.

The CPU 51 performs the interrupting processing as shown in FIG. 9 at every prescribed intervals at a different timing from the interrupting processing as shown in FIG. 6. First, in this interrupting processing, the CPU 51 determines whether or not the operation mode registered as the default operation mode is now set as the set operation mode (step S30).

If not set (N in step S30), the CPU 51 determines whether or not the operation of the multi-switches 3a-3h has not been performed for 8 sec (=prescribed time) or longer (step S31). If the operation of the multi-switches 3a-3h has not been performed for 8 sec or longer (Y in step S31), the CPU 51 performs the same default processing as in step S1 in FIG. 5 (step S31). The CPU 51 returns to the original state.

On the other hand, if the operation mode registered as the default operation mode is now set as the set operation mode (Y in step S30), or even if not, the duration time of the state where the operation of the multi-switches 3a-3h is shorter than 8 sec (N in step S31), the CPU 51 immediately returns to the original state.

By way of the interrupting processing, even when the other operation mode than the default operation mode has been set, if the multi-switches 3a-3h are not operated continuously for 8 sec or longer, the default operation mode is set as the set operation mode by the default processing. Therefore, the number of times of selection of the operation mode by the AUD selective switch 1a or AIR selective switch 1b can be reduced more greatly.

In the multi-function switch device described hitherto, when the selective switch 1a or 1b is subjected to the long-time pressing, the CPU 51 is adapted to make the registering/canceling of the default operation mode, and when the selective switch 1a or 1b is subjected to the switch operation, the CPU 51 is adapted to select the set operation mode. Therefore, the selective switch for selecting the operation mode can be used to make the registering/canceling of the default operation mode. This contributes to reduce the production cost.

As described above, if the operation mode with high frequency of use is registered manually or automatically, when any operation mode is not selected by the selective switch la or 1b, the operation mode with the high frequency of use can be set as the set operation mode. For this reason, the number of times of selecting the operation mode by the selective switch 1a or 1b can be reduced.

In the embodiment described above, the multi-function switch device was designed so that the default operation mode can be registered automatically or manually, but can be designed so that the default operation mode can be registered only automatically.

Embodiment 2

Now referring to the drawings, an explanation will be given of a second embodiment of this invention. FIG. 11 shows a combination panel which constitutes a multi-function switch device according to this invention. In FIG. 11, like reference numerals refer to like elements in the first embodiment shown in FIG. 2.

The multi-function switch device according to the second embodiment is designed so that the default operation mode can be registered for plural operators. This multi-function switch device includes default switches 6a-6c as well as the AUD selective switch 1a, AIR switch 1b and multi-switches 3a-3h. The default switches 6a-6c serve to select one of a plurality of default operation modes which have been previously registered. As in the first embodiment, these default switches are connected to the μ COM 5, respectively.

Referring to the flowcharts of FIGS. 5, 6, 9, 12 and 13 which show the processing procedure of the CPU 51, an explanation will be given of the operation of the multi-function switch according to this embodiment. First, the CPU 51 performs substantially the same processing as described with reference to FIG. 5. In the second embodiment, since the automatic registering processing is not made, the processing described in steps S6, S9, S13 and S15 is not done.

The CPU 51 is adapted so that interruption of the manual registering processing is made at every prescribed time intervals. Referring to the flowchart of FIG. 12, an explanation will be given of the details of the manual registering processing in the second embodiment. First, if the long-time pressing of the default switch 6a which is the third operation is made by the operator (Y in step S20), the CPU 51 registers the operation mode which is now set as the set operation mode as a first default operation mode (step S20I), and thereafter returns to the original state.

Likewise, if the default switch 6b is subjected to the long-time pressing (Y in step S20j), the CPU 51 registers the set operation mode as a second default operation mode (step S20k). If the default switch 6c is subjected to the long-time pressing (Y in step S201) ,the CPU 51 registers the set operation mode as a third default operation mode (step S20m), and thereafter returns to the original state.

By way of the manual registering processing described above, the CPU 51 serves as a manual registering means. The default switches 6a-6c serve as a default operation mode selecting means, respectively.

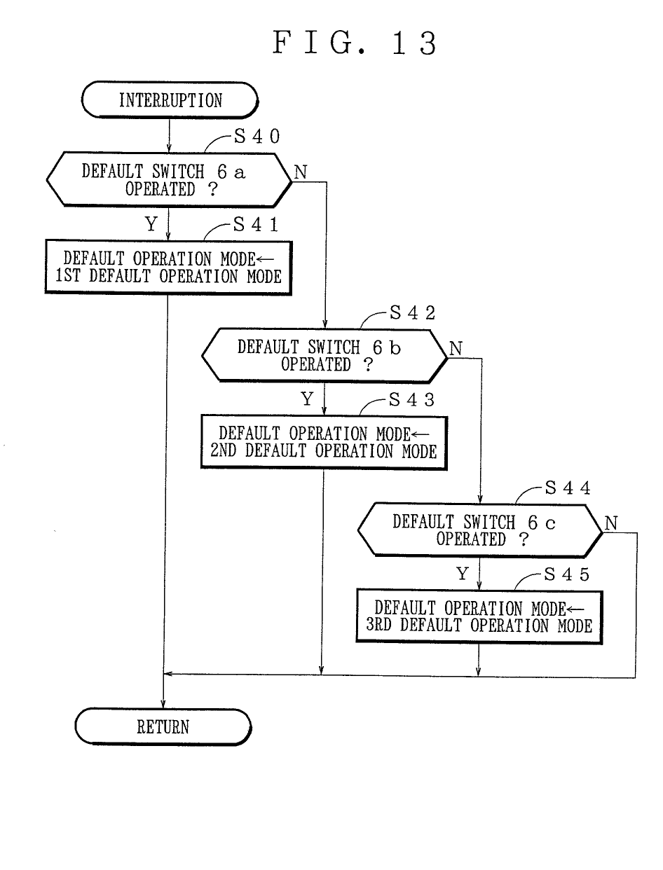

The CPU 51 performs the interruption processing as shown in FIG. 13 at every prescribed intervals at the different timings from those of the manual registering processing of FIG. 12. In the interruption processing, if the default switch 6a is subjected to the switch operation which is a fourth operation (Y in step S40), the CPU 51 registers the first default operation mode as the default operation mode (step S41). In this step S41, the CPU 51 serves as a registering invalidating means to invalidate the second and the third default operation mode.

Likewise, if the default switch 6b is subjected to the switch operation (Y in step S42), the CPU 51 registers the second default operation mode as the default operation mode (step S43). If the default switch 6c is subjected to the switch operation (Y in step S44), the CPU 51 registers the third default operation mode as the default operation mode (step S45), and returns to the original state.

In the interruption processing described above, the default switches 6a-6c serve as the selective operation means. The CPU 51 also performs the same interruption processing as shown in FIG. 9.

In the multi-function switch device described above, when the default switches 6a-6c are subjected to the long-time pressing operation, the CPU 51 registers the first to the third default operation mode, and when the default switches 6a-6c are subjected to the switch operation, the CPU 51 selects the one of the registered default operation modes. Thus, the default operation modes can be selected by using the switches for registering so that it is not necessary to provide the switches for dedicated purposes. This contributes to reduce the production cost.

When the multi-function switch device is used by plural operators, the operation modes with high frequency of use are different for different operators. In view of this, the multi-function switch device according to this embodiment is provided with a plurality of default switches 6a-6c for registering the default operation modes. Since one of the default operation modes thus registered can be selected, the plural operators can register the default operation mode which are optimum for themselves.

In the second embodiment, the multi-function switch device was so adapted that the default operation mode is registered manually, but may be adapted so that the default operation mode is registered automatically as in the first embodiment.

In the first and the second embodiment, the operation mode was explained as the audio operation mode and the air conditioner mode. However, it should not be limited to these two modes, but may also include the other operation mode, e.g. a car navigation operation mode for operating a car navigation device.

What is claimed is:

1. A multi-function switch device comprising:
first selecting means for selecting one of a plurality of operation modes to be set as a set operation mode;
setting means for setting the selected operation mode as the set mode;
display means for displaying a character corresponding to the set operation mode;
operating means for executing an operation corresponding to said character;
monitoring means for monitoring an operating status of said first selecting means and said operating means; and
automatic registering means for automatically registering one of said plurality of operation modes as a default operation mode on the basis of an operation state of said of said first selecting means or said operating means, wherein said setting means sets said default operation mode as the operation mode when no operation mode is selected by said first selecting means.

2. A multi-function switch device according to claim 1, wherein said operation status is number of times of operation of said operating means counted for each operation mode, number of times of selection of said operation mode by said selecting means or a set time for each said operation modes.

3. A multi-function switch device according to claim 1,
manual registering means having second selecting means for selecting one of a plurality of operation modes to be registered as a default operation mode, said manual registering means registering the selected operation mode manually as the default operation mode.

4. A multi-function switch device according to claim 3, further comprising:
canceling means for canceling said default operation mode registered by said manual registering means when it is selected by said second selecting means.

5. A multi-function switch device according to claim 3, further comprising:
first invalidating means for invalidating said default operation mode registered by said automatic registering means when it is registered by said manual registering means.

6. A multi-function switch device according to claim 3, wherein said setting means sets the operation mode corresponding to the first selecting means as the set operation mode when the first selecting means is operated in a first predetermined selecting operation, and
said manual registering means uses the first selecting means as the second selecting means to register the operation mode corresponding to the first selecting means as the default operation mode when the first selecting means is operated in a second predetermined selecting operation.

7. A multi-function switch device comprising:
first selecting means for selecting one of a plurality of operation modes to be set as a set operation mode;
setting means for setting the selected operation mode as the set operation mode;
display means for displaying a character corresponding to the set operation mode;
operating means for executing an operation corresponding to said character; and
manual registering means having a second selecting means for selecting one of a plurality of operation modes to be registered as a default operation mode, said manual registering means registering the selected operation mode manually as the default operation mode,
wherein said setting means sets said default operation mode as the set operation mode when no operation mode is selected by said second selecting means.

8. A multi-function switch device according to claim 7, wherein said manual registering means includes a plurality of registering units, further comprising
third selecting means for selecting one of default operation modes registered by said plurality of registering units; and
second invalidating means for invalidating the other default operation modes than the default operation mode selected by said third selecting means.

9. A multi-function switch device according to claim 8, wherein said second invalidating means invalidates the other default operation mode than the default mode corresponding to the third selecting means when said third selecting means is operated in a third predetermined selecting operation, and
said manual registering means uses the third selecting means as the second selecting means to register the operation mode corresponding to the first selecting means as the default operation mode when the third selecting means is operated in a fourth predetermined selecting operation.

10. A multi-function switch device according to claim 1, wherein
said setting means sets said default operation mode as the set operation mode when the said default operation mode is not said set operation mode and said operating means is not operated continuously for a predetermined time or longer.
